(19) United States
(12) Patent Application Publication
(10) Pub. No.: US 2020/0028686 A1
(43) Pub. Date: Jan. 23, 2020

(54) SYSTEMS AND METHODS FOR EXTENDING THE DOMAIN OF BIOMETRIC TEMPLATE PROTECTION ALGORITHMS FROM INTEGER-VALUED FEATURE VECTORS TO REAL-VALUED FEATURE VECTORS

(71) Applicant: Florida Atlantic University Board of Trustees, Boca Raton, FL (US)

(72) Inventors: Koray Karabina, Boca Raton, FL (US); Shoukat Ali, Boca Raton, FL (US); Emrah Karagoz, Boca Raton, FL (US)

(21) Appl. No.: 16/419,840

(22) Filed: May 22, 2019

Related U.S. Application Data
(60) Provisional application No. 62/702,057, filed on Jul. 23, 2018.

(51) Int. Cl. H04L 9/32; H04L 29/06; H04L 9/06

(52) U.S. Cl. CPC H04L 9/3231; G06K 9/00288; H04L 9/0618; H04L 63/0861

(57) ABSTRACT

Systems and methods for generating a secure biometric template. The methods comprise: obtaining biometric data from an individual, the biometric data represented as a real-valued feature vector x; mapping the real-valued feature vector x to an integer-valued feature vector X by multiplying each component of the real-valued feature vector x by a value s and performing a nearest integer function using results of the multiplying; and generating the secure biometric template by a cryptographic algorithm using the integer-valued feature vector X. s is a function of n, p and [symbol] . n is the length of the real-valued feature vector x. p is a known parameter of a distance function used to determine a distance between two biometric templates. [symbol] is a parameter controlling the accuracy preserving feature of the present solution. The secure biometric template is used for computer security purposes.

### CROSS-REFERENCE TO RELATED APPLICATIONS

The present application claims priority to U.S. Patent Ser. No. 62/702,057 which was filed on Jul. 23, 2018. The content of this patent application is incorporated herein in its entirety.

### STATEMENT AS TO RIGHTS IN INVENTION MADE UNDER FEDERALLY-SPONSORED RESEARCH AND DEVELOPMENT

This invention was made with government support under Grant No. 1718109, awarded by the National Science Foundation. The government has certain rights in the invention.

### BACKGROUND

### Statement of the Technical Field

The present disclosure relates generally to data processing systems. More particularly, the present disclosure relates to implementing systems and methods for extending the domain of biometric template protection algorithms from integer-valued feature vectors to real-valued feature vectors.

### Description of the Related Art

Biometrics-based cyber security technologies offer significant advantages in authentication, identification, and access control mechanisms. Convenience and fraud prevention requirements in systems create a growing demand for biometric solutions in a wide range of sectors and applications, such as mobile, healthcare, record and personnel management, banking, and border security. The U.S. Office of Biometric Identity Management provides large scale biometric identification services to prevent identity fraud and facilitate legitimate travel. In Aadhar, India's biometric identity management system, more than 1.1 billion citizens have been enrolled. The popularity of biometrics technologies and their world-wide deployment makes biometric applications and databases natural targets in cyber-attacks on a large scale. In 2015, for example, 5.6 million fingerprints were stolen from the U.S. Office of Personnel Management's database in a cyber-attack.

Conventional biometric identification systems consist of two phases: enrollment and verification. In the enrollment phase, a user's biometric sample is collected via a sensor, and distinctive characteristics are derived using a feature extraction algorithm. A digital representation of these characteristics (the feature vector or the template) is stored in the system database. In the verification phase, a matching algorithm takes a pair of templates as input, and outputs a score. A decision (accept or reject) is made based on the matching score. Therefore, biometric templates should be stored in some protected form to guard against adversarial attacks. Since 1994, there has been tremendous research and development efforts for creating secure biometric schemes. In the most general terms, biometric template protection methods can be classified under four main categories: Biometric Cryptosystems (“BC”); Cancelable Biometrics (“CB”); Keyed Biometrics (“KB”); and Hybrid Biometrics (“HB”).

In BC and SC (whence in HB), cryptographic functions and transformations are the main tools to create secure templates. By construction, the underlying cryptographic primitives are defined over some particular discrete domains, and therefore, feature vectors are supposed to be some binary, or integer-valued vectors. For example, some conventional BC- and SC-based secure fingerprint and iris identification algorithms assume that feature vectors are represented as fixed length binary vectors, and the Hamming distance (and some variants of the Hamming distance) is used as a way of measuring the similarity between feature vectors. More generally, a large class of template protection algorithms tend to assume that feature vectors are integer valued, and the similarity scores are calculated based on Hamming distance, set difference distance, or edit distance. On the other hand, biometric data, in general, is represented through real-valued feature vectors as in the case of face recognition and keystroke dynamics. Therefore, many of the known secure template constructions are not usable or do not provide satisfactory results in biometric data applications.

### SUMMARY

The present disclosure concerns implementing systems and methods for generating a secure biometric template. The methods comprise: obtaining by a computing device biometric data from an individual (where the biometric data is represented as a real-valued feature vector x); mapping by the computing device the real-valued feature vector x to an integer-valued feature vector X by multiplying each component of the real-valued feature vector x by a value s and performing a nearest integer function using results of the multiplying; and generating the secure biometric template by a cryptographic algorithm (e.g., an NTT-SEC-R algorithm) using the integer-valued feature vector X as an input. The secure biometric template is used for computer security purposes (e.g., identification, authentication and/or access authorization). s is a function of n, p and ϵ̅. n is the length of the real-valued feature vector x. p is a known parameter of the Minkowski distance function used to determine a distance between two secure biometric templates. ϵ̅ is a parameter ensuring retention of biometric data accuracy while the secure biometric template is being generated.

In general, the secure biometric template is stored in a data store (e.g., a database). The stored secure biometric template is used as a reference biometric template in a user authentication process. The user authentication process comprises: obtaining biometric data from the individual or another individual, the biometric data represented as a real-valued feature vector y; mapping the real-valued feature vector y to an integer-valued feature vector Y by multiplying each component of the real-valued feature vector y by the same value s used for x and performing a nearest integer function using results of the multiplying; and generating a new secure biometric template by using the same above cryptographic algorithm having the integer-valued feature vector Y as an input. An algorithm is performed to determine the similarity (e.g., the distance d) between the new secure biometric template and the reference biometric template. The distance d is compared to a threshold value T that is a function of s. The individual or another individual is authenticated when the distance d is equal to or less than the threshold value T.

In those or other scenarios, the methods involve selected s by obtaining inputs: a biometric dataset DS; a threshold value t with reference to a desired false accept rate and a desired false reject rate simulated over DS; I_{FAR} which is defined by Equation

I_{FAR}=[FAR1,FAR2]=[FAR(t)−ϵ̅,FAR(t)+ϵ̅],

where FAR(t) comprises a value that represents a measure of the likelihood that a biometric security system will incorrectly accept an access attempt by an unauthorized user; I_{FRR} which is defined by Equation

I_{FRR}=[FRR1,FRR2]=[FRR(t)−ϵ̅,FRR(t)+ϵ̅],

where FRR(t) comprise a value that represents a measure of the likelihood that the biometric security system will incorrectly reject an access attempt by an authorized user; and ϵ̅ which represents a value by which FAR(t) and FRR(t) are allowed to fluctuate and to ensure that FAR(T) and FRR(T) lie in the intervals I_{FAR} and I_{FRR}, respectively. Using the inputs, a smallest ϵ is determined such that

[FAR(t−ϵ),FAR(t+ϵ)]⊆I_{FAR}

[FRR(t+ϵ),FRR(t−ϵ)]⊆I_{FRR}

Next, s is set equal to [symbol] . MinScalar which is defined by following procedure: 1) compute the average of feature vector over all feature vectors in the dataset, depending on the (user-based or system-based) model, such that each component of the vector is the average of the absolute values of that component; 2) determine whether

FAR′((s−1)·t)∈I_{FAR} and FRR′((s−1)·t)∈I_{FRR}

over the biometric dataset DS. [symbol] is selected as s when a determination is made that

FAR′((s−1)·t)∈I_{FAR} and FRR′((s−1)·t)∈I_{FRR}

are not met.

In contrast, 1 is subtracted from s when a determination is made that

FAR′((s−1)·t)∈I_{FAR} and FRR′((s−1)·t)∈I_{FRR}

are met. The result of the subtracting is compared to MinScalar. s is set equal to [symbol] when the result of the subtracting is greater than MinScalar.

The present disclosure also concerns a method for transforming biometric feature vectors. The methods comprise: obtaining, by a computing device, biometric data from an individual, the biometric data represented as a real-valued feature vector x; mapping, by the computing device, the real-valued feature vector x to an integer-valued feature vector X by multiplying each component of the real-valued feature vector x by a value s and performing a nearest integer function using results of the multiplying; and using, by the computing device, the integer-valued feature vector X for identification of an individual, authentication of the individual, or authorization of the individual's access to the computing device.

Notably, the underlying functionality of the computing device is improved by the implementation of the mapping process because the computer security process (e.g., identification, authentication and/or authorization process(es)) is made more secure, more efficient, less resource intensive, and computationally faster as compared to that of conventional biometric template generation solutions.

### BRIEF DESCRIPTION OF THE DRAWINGS

The present solution will be described with reference to the following drawing figures, in which like numerals represent like items throughout the figures.

FIG. 1 is an illustration of an illustrative system.

FIG. 2 is an illustration of an illustration computing device architecture.

FIG. 3 is a flow diagram of an illustrative method for authenticating a user in accordance with the present solution.

FIG. 4 is a flow diagram of an illustrative method for selecting a value for s in any given application.

FIG. 5 provides a graph showing a Receiver Operating Characteristic (“ROC”) curve and an Area Under Curve (“AUC”) where underlying functions are a Euclidean Distance (“ED”) and a Manhattan Distance (“MD”) in which facial data is used, and illustrates an accuracy preserving feature of the present solution.

FIG. 6 provides a graph showing an ROC curve and an AUC where underlying functions are ED and MD in which keystroke data is used, and illustrates an accuracy preserving feature of the present solution.

FIG. 7 provides a flow diagram of an illustrative method for determining s.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present solution may be embodied in other specific forms without departing from its spirit or essential characteristics. The described embodiments are to be considered in all respects only as illustrative and not restrictive. The scope of the present solution is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present solution should be or are in any single embodiment of the present solution. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One skilled in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

Reference throughout this specification to “one embodiment”, “an embodiment”, or similar language means that a particular feature, structure, or characteristic described in connection with the indicated embodiment is included in at least one embodiment of the present solution. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

A large class of template protection algorithms tend to assume that feature vectors are integer-valued, and the similarity scores are calculated based on a Hamming distance, a set difference distance, or an edit distance. On the other hand, biometric data, in general, is represented through real-valued feature vectors. Therefore, many of the known secure template constructions are not immediately applicable when feature vectors are composed of real numbers. In this document, a method is proposed to extend the domain of biometric template protection algorithms from integer-valued feature vectors to real valued feature vectors through a simple and intuitive transformation. The present solution is accuracy-preserving.

Below, a method is proposed to extend the domain of biometric template protection algorithms from integer-valued feature vectors to real-valued feature vectors. The present solution is derived from a transformation of biometric data. Given a (non-cryptographic) biometric authentication system that takes real-valued vectors as input, and runs at false accept rate FAR (t) and false reject rate FRR (t) for some threshold value t, the present solution yields a new system that extends the domain and is accuracy-preserving. With regard to extending the domain, the new system takes real-valued vectors and transforms them into integer-valued vectors before template generation and matching. This allows the use of a large class of cryptographic secure template generation and matching algorithms because their domain consists of integer-valued feature vectors. With regard to accuracy-preserving, the new system runs at false accept rate FAR′ (T) and false reject rate FRR′ (T). Here, T is determined as a parameterized function of the original system's threshold value t. More importantly, FAR′ (T) and FRR′ (T) can be made arbitrarily close to FAR (t) and FRR (t), respectively, by choosing some suitable parameters.

In this document, the accuracy of the present solution is evaluated over two publicly available biometric datasets: the LFW face dataset and the keystroke-s dynamics dataset. Biometric features in both of these datasets are represented as real-valued vectors. As an application of the present construction, some concrete system parameters are used to convert these feature vectors into integer-valued vectors and provide a comparative accuracy analysis for the new system. The results are comparable to previously reported accuracy results derived from the same datasets using some state-of-the-art biometric recognition algorithms.

As stated previously, a major advantage of transforming real-valued feature vectors into integer-valued feature vectors is the ability to cryptographically secure biometric templates. In order to evaluate the practical impact of the present solution, a noise tolerant secure template generation and comparison algorithm NTT-Sec is implemented over the LFW face dataset and the keystroke-s dynamics dataset.

Implementing Systems

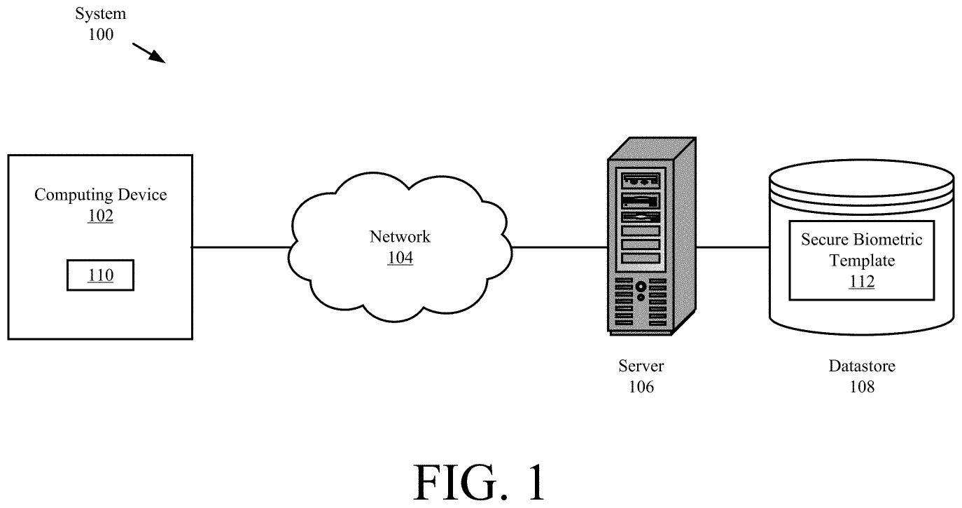

Referring now to FIG. 1, there is provided an illustration of an illustrative system 100 implementing the present solution. System 100 is generally configured to facilitate an extension of the domain of biometric template protection algorithms from integer-valued feature vectors to real-valued feature vectors. Accordingly, system 100 comprises a computing device 102 that is able to obtain or access the real-valued feature data vectors. In some scenarios, the real-valued feature data vectors 110 is temporarily stored in a datastore 108, and is made accessible via network 104 and server 106. Network 104 can include, but is not limited to, the Internet or an Intranet. In other scenarios, the real-valued feature data vectors 110 are temporarily stored locally on computing device 102 rather than remotely in the datastore 108. The real-valued feature data vectors 110 can comprise digital representations of distinctive biometric characteristics of one or more people. The real-valued feature data vectors 110 are processed by the computing device 102 to provide an accuracy-preserving transformation of biometric data that can be used for biometric template protection. The manner in which the real-valued feature data vectors 110 are processed will become evident as the discussion progresses. The result of this processing is a secure biometric template 112, which may be stored in the datastore 108.

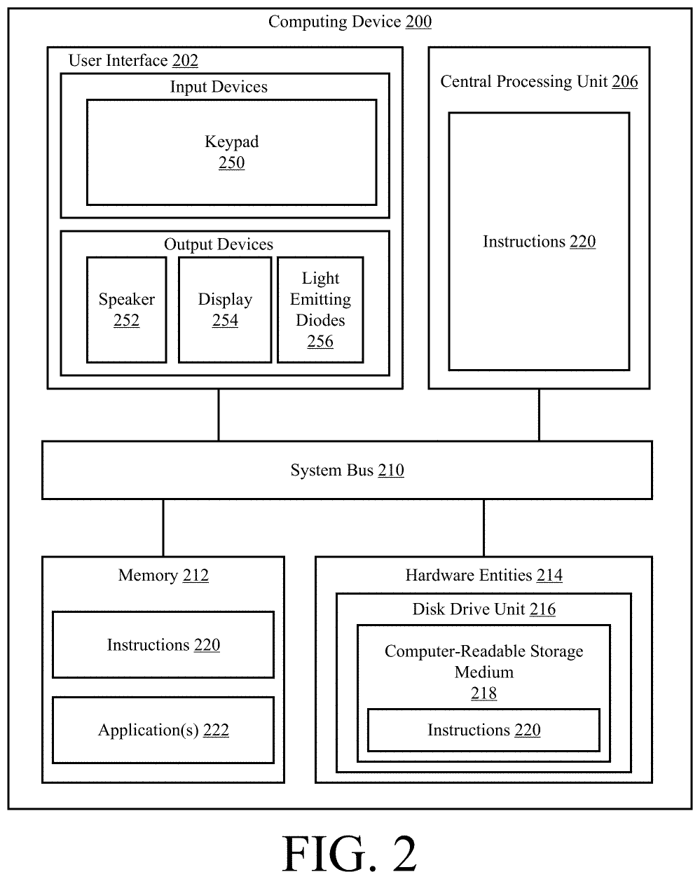

Referring now to FIG. 2, there is provided a detailed block diagram of an illustrative architecture for a computing device 200. Computing device 102 and/or server 106 of FIG. 1 is/are the same as or substantially similar to computing device 200. As such, the following discussion of computing device 200 is sufficient for understanding components 102, 106.

Notably, the computing device 200 may include more or less components than those shown in FIG. 2. However, the components shown are sufficient to disclose an illustrative embodiment implementing the present solution. The hardware architecture of FIG. 2 represents one embodiment of a representative computing device configured to facilitate a bowling process. As such, the computing device 200 of FIG. 2 implements at least a portion of the methods described herein.

Some or all the components of the computing device 200 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 2, the computing device 200 comprises a user interface 202, a Central Processing Unit (“CPU”) 206, a system bus 210, a memory 212 connected to and accessible by other portions of computing device 200 through system bus 210, and hardware entities 214 connected to system bus 210. The user interface can include input devices (e.g., a keypad 250) and output devices (e.g., speaker 252, a display 254, and/or light emitting diodes 256), which facilitate user-software interactions for controlling operations of the computing device 200.

At least some of the hardware entities 214 perform actions involving access to and use of memory 212, which can be a RAM, a disk driver and/or a Compact Disc Read Only Memory (“CD-ROM”). Hardware entities 214 can include a disk drive unit 216 comprising a computer-readable storage medium 218 on which is stored one or more sets of instructions 220 (e.g., software code) configured to implement one or more of the methodologies, procedures, or functions described herein. The instructions 220 can also reside, completely or at least partially, within the memory 212 and/or within the CPU 206 during execution thereof by the computing device 200. The memory 212 and the CPU 206 also can constitute machine-readable media. The term “machine-readable media”, as used here, refers to a single medium or multiple media (e.g., a centralized or distributed database, and/or associated caches and servers) that store the one or more sets of instructions 220. The term “machine-readable media”, as used here, also refers to any medium that is capable of storing, encoding or carrying a set of instructions 220 for execution by the computing device 200 and that cause the computing device 200 to perform any one or more of the methodologies of the present disclosure.

In some scenarios, the hardware entities 214 include an electronic circuit (e.g., a processor) programmed for biometric data processing. In this regard, it should be understood that the electronic circuit can access and run application(s) 222 installed on the computing device 200. The software application(s) 222 is(are) generally operative to facilitate the extension of the domain of biometric template protection algorithms from integer valued feature vectors to real valued feature vectors. Other functions of the software application(s) 222 will become evident as the discussion progresses.

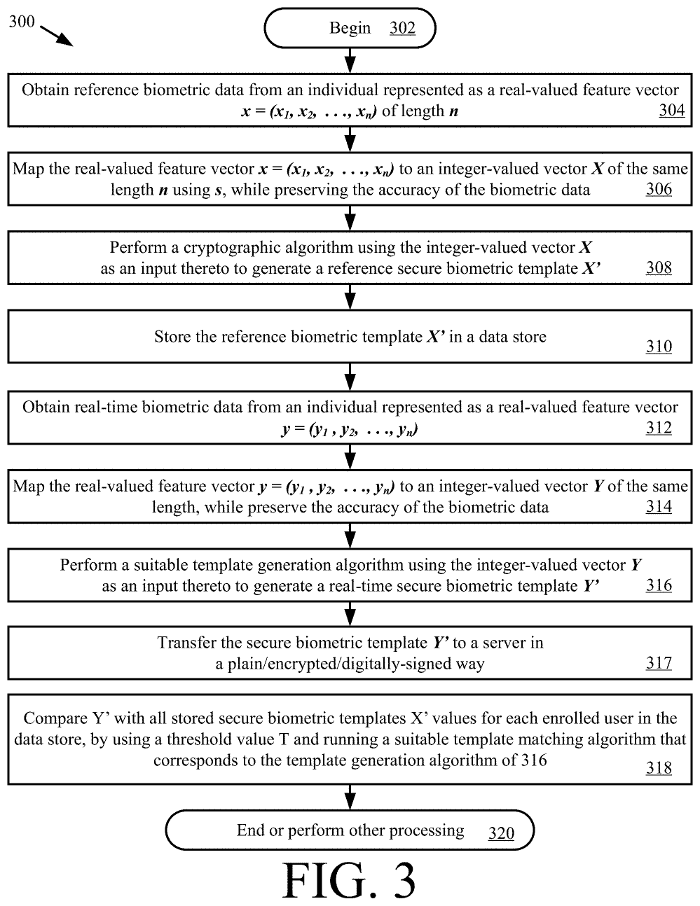

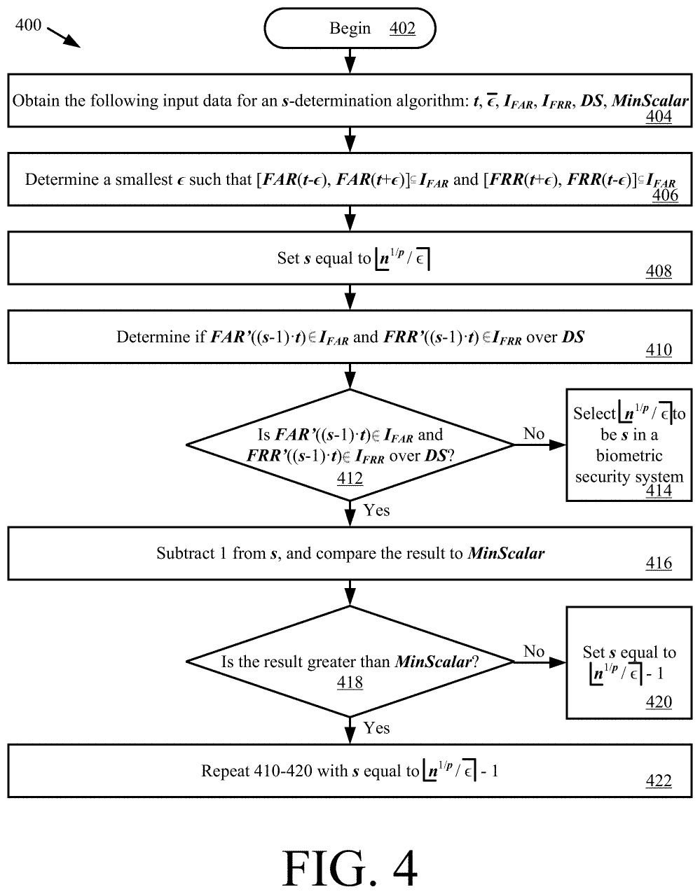

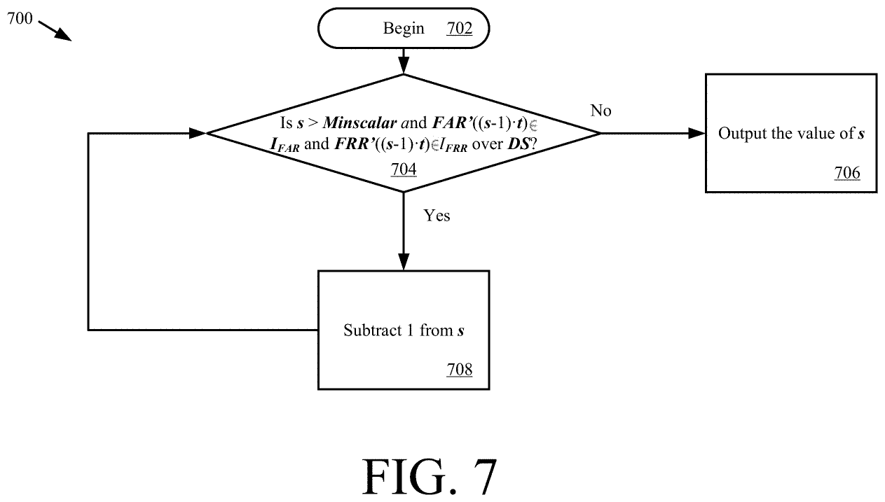

Referring now to FIG. 3, there is provided a flow diagram of an illustrative method 300 for authenticating a user in accordance with the present solution. Method 300 is shown as comprising operations 302-320. The present solution is not limited in this regard. Method 300 can include more or less operations than that shown in FIG. 3. For example, operations of a training and testing phase may be inserted between 302 and 304, and performed by a computing device (e.g., computing device 102 of FIG. 1 and/or server 106 of FIG. 1). The training and testing phase operations can involve: obtaining (a) a reference feature vector x for each individual and (b) a threshold value t for the individual in user-based models or for all the individuals in the system-based models, based on a chosen evaluation model; and determining or computing s using the obtained information (a) and (b), the process 400 of FIG. 4 and/or process 700 shown in FIG. 7. Process 400 will be discussed below in detail. Generally, process 700 involves: determining ifs is greater than Minscalar as shown by 704; outputting the value of s if s is greater than Minscalar as shown by 706; and/or subtracting 1 from s and returning to 704 is s is equal to or less than Minscalar as shown by 708. The biometric data obtained in the testing and training phase may be erased for security purposes.

Referring again to FIG. 3, method 300 begins with 302 and continues with an enrollment phase in 304-310. In 304, biometric data is obtained from an individual represented as a real-valued feature vector x which includes n real numbers x₁, x₂, . . . , xₙ. The reference biometric data may be obtained in the training and testing phase of the system. The reference biometric data can include, but is not limited to, facial data and/or keystroke data. Techniques for obtaining biometric data from individuals are well known in literature, and therefore will not be discussed herein. Any known or to be known technique for obtaining biometric data from individuals can be used herein without limitation.

Next in 306, the real-valued feature vector x is mapped to an integer-valued feature vector X which includes n integer numbers X₁, X₂, . . . , Xₙ, while preserving the accuracy of the biometric data. The mapping is achieved by performing a scale-then-round transformation StRₛ, where s is a positive real number scaling factor. The value of s was determined in the training and testing phase mentioned above. StRₛ is defined by the following Mathematical Equation (1).

StRₛ(x)=( [symbol] , [symbol] , . . . , [symbol] )=(xᵢ1,xᵢ2, . . . ,xᵢn) (1)

where └⋅┘ is the nearest integer function (e.g., a decimal number equal to or greater than 0.5 is rounded up to 1 and a decimal number less than 0.5 is rounded down to 0). s is defined by the following Mathematical Equation (2).

s≥n^{1/p}/ϵ (2)

where n is the length of the real-valued feature vector x, p is a known parameter of a distance algorithm (e.g., a Minkowski distance algorithm) used to determine the distance between a reference biometric data set x and a real-time biometric data set y during an authentication process of 318, and ϵ is a lowest parameter value that ensures that the accuracy of the biometric data is preserved. Notably, s and/or ϵ can be unique for a given individual or the same all individuals depending on the application of the present solution.

In 308, a cryptographic algorithm is performed using the integer-valued vector X as an input thereto to generate a reference secure biometric template X′. Cryptographic algorithms are well known in literature, and therefore will not be described herein. Any known or to be known cryptographic algorithm can be used herein. For example, an NTT algorithm defined by the following Mathematical Equation (3) is used here.

$$NTT \text{-} Hash \text{-} ℝ ( x ) = {\prod }_{i = 1}^{n} {( \frac{{g}_{i} + σ}{{g}_{i} - σ} )}^{{X}_{i}} \qquad ( 3 )$$

Notably, Mathematical Equation (3) represents a conventional NTT algorithm which has been modified to show that the integer-valued vector X is used as an input to the algorithm. Upon completing 308, 310 is performed where the reference biometric template xᵢ′ is stored in a data store (e.g., data store 108 of FIG. 1).

In some scenarios, the operations of 304, 306 and 308 may be performed in computing device 102 of FIG. 1. X′ obtained in the computing device 102 is securely transferred to the data store 108 of FIG. 1. The enrollment phase is supervised so that it is ensured X′ belongs to the authenticated user.

At some later time, method 300 continues with an authentication phase in 312-320. In the authentication phase, a user would like to obtain access to a given resource (e.g., a computing device 102 of FIG. 1 or a document made accessible via a server 106 of FIG. 1). Accordingly, 312 involves obtaining real-time biometric data from the individual. The real-time biometric data is represented by a real-valued feature vector x′ which includes n real numbers y₁, y₂, . . . , yₙ. The real-time biometric data can include, but is not limited to, facial data and/or keystroke data. Techniques for obtaining biometric data from individuals are well known in literature, and therefore will not be discussed herein. Any known or to be known technique for obtaining biometric data from individuals can be used herein without limitation.

Next in 314, the real-valued feature vector y is mapped to an integer-valued feature vector Y which includes n integer numbers Y₁, Y₂, . . . , Yₙ, while preserving the accuracy of the biometric data. The mapping is achieved using Mathematical Equations (1) and (2) presented above.

Next in 316, a suitable template generation algorithm (e.g., a cryptographic algorithm) is performed to generate a real-time biometric template Y′ based on the integer-valued feature vector Y. The cryptographic algorithm employed here is the same as that used in 308 to generate the reference secure biometric template X′. The real-time biometric template Y′ is transferred to a server in a plain/encrypted/digitally-signed way, as shown by 317.

In 318, the server compares the real-time secure biometric template Y′ with all stored secure biometric templates X′ values for each enrolled user in the data store, by using the threshold value T and running a suitable template matching algorithm that corresponds to the template generation algorithm of 316.

The comparison operations of 318 may be performed for user authentication purposes. The user authentication can involve: performing a distance algorithm to determine a distance dₚ between the reference biometric template xᵢ′ and the real-time biometric template X′; and comparing the distance dₚ to a threshold distance value T. The distance algorithm can include, but is not limited to, a Euclidean distance algorithm or a Minkowski distance algorithm.

An illustrative Minkowski distance algorithm is defined by the following Mathematical Equation (4).

dₚ(xᵢ′,x′ᵢ′)=(Σᵢ₌₁ⁿ|xᵢ′−x′ᵢ′|)^{p})^{1/p} (4)

where n is the length of the real-valued feature vector x, and p is a known parameter value.

The threshold distance value T is defined by the following Mathematical Equation (5).

T= [symbol] (5)

where s is defined by Mathematical Equation (2), and t is a threshold value that is obtained from training and testing on the dataset. As shown by the following Mathematical Equation (6), the user authentication is unsuccessful when the distance d is greater than the threshold distance value T, i.e., the individual is deemed to be a person other than that which is associated with the reference biometric template X′.

UA-Fail=d>T (6)

As shown by the following Mathematical Equation (7), the user authentication is successful when the distance d is equal to or less than the threshold distance value T, i.e., the individual is deemed to be the same person that is associated with the reference biometric template xᵢ′.

UA-Pass=d≤T (7)

Subsequently, 320 is performed where method 300 ends or other processing is performed (e.g., return to 304 or 312).

Referring now to FIG. 4, there is provided a flow diagram of an illustrative method 400 for selecting a value for s in any given application. Method 400 begins with 402 and continues with 404 were the following input data for smallest s-determination algorithm is obtained: t, ϵ̅, I_{FAR}, I_{FRR}, DS, MinScalar. t is a threshold value (e.g., 5.941) is obtained from training and testing on the dataset. I_{FAR} is defined by the following Mathematical Equation (8).

I_{FAR}=[FAR1,FAR2]=[FAR(t)−ϵ̅,FAR(t)+ϵ̅] (8)

where FAR(t) comprises a value (e.g., 0.03365) that represents a measure of the likelihood that a biometric security system will incorrectly accept an access attempt by an unauthorized user, and may be defined by the ratio of the number of false acceptances divided by the number of identification attempts. I_{FRR} is defined by the following Mathematical Equation (9).

I_{FRR}=[FRR1,FRR2]=[FRR(t)−ϵ̅,FRR(t)+ϵ̅] (9)

where FRR(t) comprise a value (e.g., 0.03358) that represents a measure of the likelihood that the biometric security system will incorrectly reject an access attempt by an authorized user, and may be defined by the ratio of the number of false recognitions divided by the number of identification attempts. ϵ̅ is chosen such that the error rates of the new system lies within a particular range of desired accuracy rate of the system. Stated differently, ϵ̅ represents a value (e.g., 0.01) that is selected so that FAR′(T) lies in the range of FAR1 and FAR2 of I_{FAR}, and FRR′(T) lies in the range of FRR1 and FRR2 of I_{FRR}. DS represents a sample biometric dataset for one or more individuals. MinScalar which is defined by following procedure: 1) compute the average of feature vector over all feature vectors in the dataset, depending on the (user-based or system-based) model, such that each component of the vector is the average of the absolute values of that component; 2) determine whether

FAR′((s−1)·t)∈I_{FAR} and FRR′((s−1)·t)∈I_{FRR}

over the biometric dataset DS. [symbol] is selected as s when a determination is made that

FAR′((s−1)·t)∈I_{FAR} and FRR′((s−1)·t)∈I_{FRR}

are not met.

In next 406, a smallest ϵ is determined as follows: (1) select the maximum threshold t₁ between FAR(t₁) and FRR(t₁) such that FAR(t₁)=FAR(t)−ϵ̅ and FRR(t₁)=FRR(t)+ϵ̅; (2) select the minimum threshold t₂ between FAR(t₂) and FRR(t₂) such that FAR(t₂)=FAR(t)+ϵ̅ and FRR(t₂)=FRR(t)−ϵ̅; (3) select the minimum between (t−t₁) and (t₂−t). This minimum value is ϵ and it satisfies the following

[FAR(t−ϵ),FAR(t+ϵ)]⊆I_{FAR} and [FRR(t+ϵ),FRR(t−ϵ)]⊆I_{FAR}.

Once the smallest ϵ is determined, s is set equal to [symbol] as shown by 408. In 410, a determination is made as to whether FAR′((s−1)·t)∈I_{FAR} and FRR′((s−1)·t)∈I_{FRR} over the dataset DS. If not [412:NO], then 414 is performed where the value [symbol] is selected as s to be used in a biometric security system process such as that discussed above in relation to FIG. 3. If so [412:YES], then 1 is subtracted from s, and the result of this subtraction operation is compared to the input value MinScalar. If the result is not greater than MinScalar [418:NO], then the value [symbol] −1 is selected as s to be used in a biometric security system process such as that discussed above in relation to FIG. 3. If the result is equal to or less than MinScalar [418:YES], then 422 is performed where the operations of 410-420 are repeated with s equal to [symbol] −1.

The following discussion is provided to further explain the above described process of FIGS. 3-4, and also provide a full understanding of the theory behind the above described process of FIGS. 3-4.

In this section, a more detailed explanation is provided for the method for extending the domain of biometric template protection algorithms from integer-valued feature vectors to real-valued feature vectors. Some theoretical estimates are also derived on the accuracy-preserving properties of the present solution. The theoretical findings will further be evaluated over two publically available biometric datasets: the LFW face dataset and the keystroke-se dynamics dataset.

Let s be a positive real number called the scaling factor. The following scale-then-round transformation StRₛ is performed to map a real-valued vector of length n to an integer-valued vector of the same length. The real-valued vector is expressed as x=(x₁, x₂, . . . , xₙ). The scale-then-round transformation StRₛ is defined by the following Mathematical Equation (11).

StRₛ(x)=(└sx₁┘,└sx₂┘, . . . ,└sxₙ┘) (11)

where └˜┘ is the nearest integer function.

Now let a distance function d on [symbol] ⁿ be given so that it satisfies the homogeneity and translation properties, that is, for any x, yϵ [symbol] ⁿ and uϵ [symbol] it satisfies d(ux, uy)=|u|d(x,y) and d(x,y)=d(x+u, y+u). The following lemma is provided.

Lemma 1. Let the transformation StRₛ: [symbol] ⁿ→ [symbol] ⁿ and the distance function d be defined as above. Let x, yϵ [symbol] ⁿ be any real-valued vectors and denote their transformations as the integer valued vectors X=StRₛ(x) and Y=StRₛ(y) in [symbol] ⁿ. Then

|d(X,Y)−sd(x,y)|≤2ϵₘₐₓ

where

$${ϵ}_{max} = {max}_{u ∈ {ℝ}^{n}} d ( su , {StR}_{s} ( u ) ) .$$

### Equivalently,

sd(x,y)−2ϵₘₐₓ≤d(X,Y)≤sd(x,y)+2ϵₘₐₓ

and

$$\frac{d ( X , Y ) - 2 {ϵ}_{max}}{s} \leq d ( x , y ) \leq \frac{d ( X , Y ) + 2 {ϵ}_{max}}{s} .$$

Proof: Using the triangular inequality on both d(sx, sy) and d(X,Y), the following is provided

d(X,Y)≤d(X,sx)+d(Y,sy)+d(sx,sy)

and

d(sx,sy)≤d(X,sx)+d(Y,sy)+d(X,Y).

Since d(sx, sy)=sd(x,y) and both d(X, sx) and d(Y, sy) are bounded above by ϵₘₐₓ, the desired result is provided.

Lemma 1 shows that given a pair of vectors x, yϵ [symbol] ⁿ, d(X,Y)/s lies in the neighborhood of the distance d(x,y) up to an error margin of 2ϵₘₐₓ/s. In the next theorem, it is observed that if the Minkowski distance dₚ(x,y)=(Σᵢ₌₁ⁿ|xᵢ−yᵢ|^{p})^{1/p} is deployed, then dₚ(X,Y)/s converges to dₚ(x,y). This result will later be used in Theorem 2 where the error rates of a system with integer valued vectors is compared with a system with real valued vectors.

Theorem 1. Let dₚ be the Minkowski distance defined on [symbol] ⁿ, and let X=StRₛ(x) and Y=StRₛ(y) as before. For a given ϵ>0, if a scalar s is chosen such that s≥n^{1/p}/ϵ, then |d(X,Y)/s−d(x,y)|≤ϵ

for all x, yϵ [symbol] ⁿ.

Proof. Note that ϵₘₐₓ is defined by Mathematical Equation (2).

$${ϵ}_{max} = {max}_{u ∈ {ℝ}^{n}} {d}_{p} ( su , {StR}_{s} ( u ) ) \leq {( {\sum }_{i = 1}^{n} {( 1 / 2 )}^{p} )}^{1 / p} = \frac{{n}^{1 / p}}{2} \qquad ( 2 )$$

where the last inequality follows because |suᵢ−└suᵢ┘|≤½ for all i. Now, for a given ϵ>0, choose s such that s≥n^{1/p}/ϵ. This implies n^{1/p}/s≤ϵ, and it follows from Lemma 1 and Mathematical Equation (2) that

|d(X,Y)/s−d(x,y)|≤2ϵₘₐₓ/s≤n^{1/p}/s≤ϵ

as required.

Next, some theoretical estimates are provided on the new system's False Accept Rate (“FAR”) and False Reject Rate (“FRR”) as a function of the original system's error rates.

Let GenP and ImpP denote the list of genuine pairs and the list of imposter pairs, respectively. Corresponding to these lists, let GenP′ and ImpP′ denote the lists of transformed version of GenP and ImpP respectively, defined as

GenP′={(StRₛ(x),StRₛ(y)):(x,y)∈GenP}

ImpP′={(StRₛ(t),StRₛ(y)):(x,y)∈ImpP}

Thus, # GenP=# GenP′ and # ImpP=# ImpP′ where the symbol # represents the number of pairs. Note that all of them are lists, not sets. Therefore, it is possible to see identical pairs, especially in the lists of vectors, i.e., there may exist (x₁, y₁), (x₂, y₂) such that (x₁, y₁)≠(x₂, y₂) but (StRₛ(x₁), StRₛ(y₁))=(StRₛ(x₂), StRₛ(y₂)).

For a distance function d on [symbol] ⁿ and tϵ [symbol] ⁺, the FAR(t) and FAR(t) are defined as follows:

$$FAR ( t ) = \frac{\# \{ ( x , y ) ∈ ImpP : d ( x , y ) \leq t \}}{\# ImpP}$$

$$FRR ( t ) = \frac{\# \{ ( x , y ) ∈ GenP : d ( x , y ) > t \}}{\# GenP} ,$$

Now, the corresponding rates for Tϵ [symbol] ⁺ are defined as follows:

$${FAR}^{′} ( T ) = \frac{\# \{ ( X , Y ) ∈ {ImpP}^{′} : d ( X , Y ) \leq T \}}{\# {ImpP}^{′}}$$

$${FRR}^{′} ( T ) = \frac{\# \{ ( X , Y ) ∈ {ImpP}^{′} : d ( X , Y ) > T \}}{\# {ImpP}^{′}} ,$$

Lemma 2. Let s be the scaling factor in transformation StRₛ and define

$${ϵ}_{max} = {max}_{u ∈ {ℝ}^{n}} d ( su , {StR}_{s} ( u ) ) .$$

### Then

$$FAR ( t - \frac{2 {ϵ}_{max}}{s} ) \leq {FAR}^{′} ( st ) \leq FAR ( t + \frac{2 {ϵ}_{max}}{s} )$$

$$and$$

$$FRR ( t + \frac{2 {ϵ}_{max}}{s} ) \leq {FRR}^{′} ( st ) \leq FRR ( t - \frac{2 {ϵ}_{max}}{s} ) .$$

Proof. For the first inequality, define (X,Y)=(StRₛ(x), StRₛ(y)) for an imposter pair (x,y) in the list ImpP. Then by using the inequalities in Lemma 1, the following is provided

$$d ( x , y ) \leq t - \frac{2 {ϵ}_{max}}{s} d ( X , Y ) \leq s ( t - \frac{2 {ϵ}_{max}}{s} ) + 2 {ϵ}_{max} = st$$

$$and$$

$$d ( X , Y ) \leq st d ( x , y ) \leq \frac{st + 2 {ϵ}_{max}}{s} = t + \frac{2 {ϵ}_{max}}{s} .$$

These inequalities mean that

Any impostor pair (x,y) having distance less than or equal to

$$t - \frac{2 {ϵ}_{max}}{s} ,$$

which is already counted in the rate

$$FAR ( t - \frac{2 {ϵ}_{max}}{s} ) ,$$

has its transformed pair (X,Y) with a distance less than or equal to st. So the transformed pair (X,Y) is needed to be counted in the rate FAR′ (t). Thus,

$$FAR ( t - \frac{2 {ϵ}_{max}}{s} ) \leq {FAR}^{′} ( st ) .$$

Any pair (X,Y) in the list ImpP′ having a distance less than or equal to st, which is already counted in the rate FAR′ (st), has its pre-transformed imposter pair (x,y) in the list ImpP with a distance less than or equal to

$$t + \frac{2 {ϵ}_{max}}{s} .$$

So this imposter pair (x,y) is needed to be counted in the rate

$$FAR ( t + \frac{2 {ϵ}_{max}}{s} ) .$$

### Thus,

$${FAR}^{′} ( st ) \leq FAR ( t + \frac{2 {ϵ}_{max}}{s} ) .$$

So, the first desired inquality is provided.

For the second inequality, now let (X,Y) denote the transformation (StRₛ(x), StRₛ(y)) for a genuine pair (x,y) in the list GenP. Then by using the inequalities in Lemma 1, the following is provided

$$d ( x , y ) > t + \frac{2 {ϵ}_{max}}{s} d ( X , Y ) > s ( t + \frac{2 {ϵ}_{max}}{s} ) - 2 {ϵ}_{max} = st$$

$$And$$

$$d ( X , Y ) > st d ( x , y ) > \frac{st - 2 {ϵ}_{max}}{s} = t - \frac{2 {ϵ}_{max}}{s} .$$

These inequalities mean that

Any genuine pair (x,y) in the list GenP having a distance greater than

$$t + \frac{2 {ϵ}_{max}}{s} ,$$

which is already counted in the rate

$$FRR ( t + \frac{2 {ϵ}_{max}}{s} ) ,$$

has its transformed pair (X,Y) with a distance greater than st. So the transformed pair (X,Y) is needed to be counted in the rate FRR′ (st) Thus,

$$FRR ( t + \frac{2 {ϵ}_{max}}{s} ) \leq {FRR}^{′} ( st ) .$$

Any pair (X,Y) in the list GenP′ having a distance greater than st, which is already counted in the rate FRR′ (st), has a pre-transformed genuine pair (x,y) in the list GenP with a distance greater than

$$t - \frac{2 {ϵ}_{max}}{s} .$$

So this genuine pair (x,y) is needed to be counted in the rate

$$FRR ( t - \frac{2 {ϵ}_{max}}{s} ) .$$

### Thus,

$${FRR}^{′} ( st ) \leq FRR ( t - \frac{2 {ϵ}_{max}}{s} ) .$$

So the second desired inquality is provided.

Theorem 2. Let dₚ be the Minkowski distance defined on [symbol] ⁿ, and let X=StRₛ(x), Y=StRₛ(y) as before. For a given ϵ>0, if a scalar s is chosen such that s≥n^{1/p}/ϵ, then

FAR(t−ϵ)≤FAR′(st)≤FAR(t+ϵ)

And

FRR(t+ϵ)≤FRR′(st)≤FRR(t−ϵ).

Proof. Let ϵ>0 be given and choose s such that s≥n^{1/p}/ϵ. In Theorem 1, it was observed that

2ϵₘₐₓ/s≤n^{1/p}/s≤ϵ.

Using this inequality together with the inequality

$${FAR}^{′} ( st ) \leq FAR ( t + \frac{2 {ϵ}_{max}}{s} )$$

For Lemma 2, and the fact that FAR(t₂)≥FAR(t₁) for t₂≥t₁, the following is obtained

$${FAR}^{′} ( st ) \leq FAR ( t + \frac{2 {ϵ}_{max}}{s} ) \leq FAR ( t + ϵ ) .$$

This proves one of the four inequalities in the statement, and the other three inequalities can be proved similarly.

Remark 1. Give the biometric authentication system that takes real-values feature vectors as inputs, deploys Minkowski distance dₚ in its matching algorithm, and runs at FAR(t) and FRR(t), Theorem 2 assures the existence of a scalar s that can be used to transform the system to integer-valued vectors, deploys the same dₚ in its matching algorithm, and runs at FAR′(st) and FRR′(st) that are arbitrarily close to FAR(t) and FRR(t) of the original system.

Remark 2. Notably, the lower bound n^{1/p}/ϵ for s is a sufficient but not necessary condition to get the desired inequalities in Theorem 2. Therefore, in practice, it can be expected that one can choose much smaller values than n^{1/p}/ϵ for the scalar s and still assure that the new system's accuracy is in a close neighborhood of the original system's accuracy. In particular, if the domain of the vectors u∈ [symbol] ⁿ in the inequality

$${ϵ}_{max} = {max}_{u ∈ R} {d}_{p} ( su , {StR}_{s} ( u ) ) \leq \frac{{n}^{1 / p}}{2}$$

in Mathematical Equation (2) are restricted from [symbol] ⁿ to the underlying biometric feature space, then the upper bound n^{1/p}/2 in the above inequality could be made smaller, which in turn would result in a smaller lower bound for s in Theorem 2. Even though it seems challenging to estimate a generic tighter upper bound for ϵₘₐₓ, whence a smaller lower bound for s in Theorem 2, this gap can be addressed between theory and practice as explained below.

Remark 3. In some scenarios, smaller values of s are used in cryptographic secure template generation algorithms due to the smaller size of the resulting feature vectors and the smaller threshold values. s should be chosen sufficiently large to prevent dictionary attacks. Therefore, in light of Theorem 2 and Remark 2, a procedure is outlined in Algorithm 2 to determine a suitable scalar so and a threshold T₀ from a given original system. An assumption is made that the original system deploys the distance function

dₚ(x,y)=(Σ(xᵢ−yᵢ)^{p})^{1/p},

and has some desired rates FAR(t₀), FRR(t₀), where FAR(t) and FRR(t) are measured over some dataset DS. For example, t₀ may be fixed so that the system runs at the equal error rate EER=FAR(t₀)=FRR(t₀). The procedure outputs a value of s₀≥MinScalar and a threshold value T₀ for which the new system's accuracy is in a close neighborhood of the original system's accuracy. More particularly, new parameters will assure that FAR′(T₀)ϵ[FAR(t₀)−ϵ̅[FAR(t₀)−ϵ̅, FAR(t₀)+ϵ̅] and FRR′(T₀)ϵ[FRR(t₀)−ϵ̅ [FRR(t₀)−ϵ̅, FRR(t₀)+ϵ̅] for a given ϵ̅>0, where dₚ(X,Y) is used to compute the distance between integer-valued vectors X=StRₛ(x) and Y=StRₛ(y). In practice, ϵ̅ should be chosen so that the new rates FAR′(T₀) and FRR′(T₀) are close to FAR(t₀) and FRR(t₀), respectively. The correctness of Algorithm 1 follows from Theorem 2.

Algorithm 1: How to determine suitable paramters s and T

| | Data: t₀, ϵ̅, I_{FAR} = [FAR (t₀) − ϵ̅, FAR (t₀) + ϵ̅], I_{FRR} = [FRR (t₀) ϵ̅, | |
|---|---|---|
| | FRR (t₀) + ϵ̅], DS, MinScalar | |
| | Result: s₀ ≥ MinScalar and T₀ such that FAR′ (T₀) ∈ I_{FAR} and | |
| | FRR′ (T₀) ∈ I_{FRR} | |
| 1 | Determine the smallest ϵ such that [FAR (t₀ − ϵ) , FAR (t₀ + ϵ)] ⊆ | |
| | I_{FAR} and [FRR (t₀ + ϵ) , FRR (t₀ − ϵ)] ⊆ I_{FRR} ; | |
| 2 | Set s₀ = └n^{1/p}/ϵ]; | |
| 3 | while True and s₀ > MinScalar do | |
| 4 | \| | if FAR′ ((s₀ − 1)t₀) ∈ I_{FAR} and FRR′ ((s₀ − 1)t₀) |
| | | I_{FRR} over DS then |

| | | | |
|---|---|---|---|
| 5 | \| | \| | Replace s₀ by s₀ − 1; |

| | | |
|---|---|---|
| 6 | \| | else |

| | | | |
|---|---|---|---|
| 7 | \|_ | \|_ | break; |

| | |
|---|---|
| 8 | Output s₀ and T₀ = [s₀t₀]; |

Experiment Results

In this section, the present solution was applied to two publicly available biometric datasets: the LFW face dataset and the keystrokes dynamics dataset. These datasets were selected because they are widely referenced in the literature, and the biometric features in both of these datasets are represented as real-valued vectors. As an application of the above-described construction, some concrete system parameters are proposed to convert these feature vectors into integer-valued vectors, and show that it preserves the reported results in those (public) biometric datasets.

Face

A facial dataset of Gary B. Huang et. al. is used in this experiment which is named Labeled Faces in the Wild (“LFW”) and is publicly available. The facial dataset comprises more than 13,000 face images of 5,749 people collected from the web. 1,680 of the people have two or more images included in the 13,000 face images. Among the four different available versions of the datasets, the original version of the LFW is used in the experiment.

In the given implementation, the face recognition (Python) module of Adam Geitgey is used. The Python model was built using the face recognition model in the Dlib library of Davis E. King. The face recognition model was trained on a dataset of about 3 million face images. The Histogram of Oriented Gradients (“HOG”) and the Convolutional Neural Network (“CNN”) are the two methods that we used for face detection in the present experiment. The HOG is faster than the CNN method but less accurate in detecting faces from the images. For example, it was found that CNN only failed to detect the face in Jeff_Feldman_0001.jpg while the HOG failed to detect faces in 57 images in the LFW. Therefore, the CNN detector is used in the present experiment.

In the pre-trained model of Davis E. King, the Euclidean Distance (“ED”) is measured between two 128-dimensional facial vectors. If the distance is less than or equal to 0.6, then two images are considered a match otherwise, it's a mis-match. The match and mis-match are returned as “True” and “False”, respectively, by Adam Geitgey in his face recognition module. In other words, False implies correct identification of impostors in the set of ImpP. Here, the accuracy is measured as follows

$$Accuracy = \frac{\# True in GenP + \# False in ImpP}{\# GenP + \# ImpP} = \frac{\# GenP ( 1 - FRR ) + \# ImpP ( 1 - FAR )}{\# GenP + \# ImpP}$$

Each image in the dataset is labelled with a person's name and contains that person's face image. In addition, some images contain faces of people other than the person in the label. In the present experiment, an assumption is made that the first detected face is the face of the labelled person. Under this assumption, for GenP, it was found that # True and # False were 231, 752 and 10,505, respectively. On the other hand, for ImpP, it was found that # True and # False were 515,817 and 86,778,222, respectively. So the sizes of GenP and ImpP are 242,257 and 87,294,039, respectively. Hence, the present evaluation yields 99.40% accuracy using the CNN method and threshold t=0.6 with ED; see TABLE 1.

TABLE 1
Original FAR FRR with ED

| | t = 0.47 | t = 0.54 | t = 0.6 | t = 0.66 | t = 0.94 | t = 0.99 |
|---|---|---|---|---|---|---|
| FAR | 0.0001 | 0.00089 | 0.006 | 0.0336 | 0.90 | 0.961 |
| FRR | 0.317 | 0.091 | 0.043 | 0.0334 | 0.0012 | 0.00019 |
| Accuracy | 0.999 | 0.998 | 0.994 | 0.9664 | 0.1 | 0.04 |

Note that the accuracy evaluation confirms the results reported by Davis E. King and Adam Geitgey, and also it is comparable to other state-of-the-art models. In order to provide a better sense of the accuracy evaluation, a sample of FAR and FRR is presented in TABLE 1, where the threshold values are chosen so that one can observe error rates ranging from small FAR to small FRR, and also the equal error rate EER.

Transforming LFW Feature Vectors. As mentioned before, a (detected) face image is represented by 128-dimensional real-valued vectors, and the accuracy evaluations are performed using the ED function. In this section, the proposed transformation is applied to obtain 128-dimensional integer-valued feature vectors. The ED is replaced by the Manhattan Distance (“MD”) function. This latter modification allows the simplification of the quadratic distance formula to a linear one, which eventually yields better efficiency in crpytographic computations for secure template comparison.

In the analysis, a focus is on three critical threshold values t=0.54, t=0.6, and t=0.66 from TABLE 1 so that FAR values near 0.001 can be captured, and also so that the FAR=FRR≈0.03. It should be emphasized that switching from the ED to MD has almost negligible impact on FAR and FRR as shown in the first two rows of TABLE 2.

TABLE 2

| Method | FRR@0FAR | Reference | EER |
|---|---|---|---|
| ED | t = 0.54 | t = 0.6 | t = 0.66 |
| | FRR = 0.091159 | FRR = 0.043363 | FRR = 0.033427 |
| | FAR = 0.000897 | FAR = 0.005909 | FAR = 0.033630 |
| | Accuracy = | Accuracy 0.99399 | Accuracy = |
| | 0.9989 | | 0.96637 |
| MD | t = 4.846 | t = 5.393 | t = 5.941 |
| | FRR = 0.100096 | FRR = 0.044989 | FRR = 0.03358 |
| | FAR = 0.00087 | FAR = 0.005896 | FAR = 0.03365 |
| | Accuracy = | Accuracy = | Accuracy = |
| | 0.99885 | 0.993995 | 0.96635 |
| MD₁₀₀ | t = 485 | t = 539 | t = 594 |
| | FRR = 0.099105 | FRR = 0.04497 | FRR = 0.033617 |
| | FAR = 0.00091 | FAR = 0.006007 | FAR = 0.03428 |
| | Accuracy = | Accuracy = | Accuracy = |
| | 0.99882 | 0.993886 | 0.965718 |
| MD₁₃₇₆ | T = 6668 | t = 7421 | t = 8175 |
| | FRR = 0.100088 | FRR = 0.044973 | FRR = 0.033555 |
| | FAR = 0.000873 | FAR = 0.005908 | FAR = 0.033702 |
| | Accuracy = | Accuracy = | Accuracy = |
| | 0.99885 | 0.99398 | 0.966299 |

where ED is the Euclidean Distance, and MD is the Manhattan Distance. MD₁₀₀, MD₁₃₇₆=MD where the feature vector components are scaled-then-rounded by integer 100 and 1376, respectively. The ERR column of MD₁₀₀, MD₁₃₇₆ are actually the transformed threshold w.r.t. to EER of MD as proposed herein.

The critical part is to determine a suitable scalar s using Algorithm 1. The process is explained in detail for t₀=5.941 (i.e., FAR(t₀)=0.03365 and FRR(t₀)=0.03358) over the dataset DS=LFW. First, we choose ϵ̅=0.01 so that the new system's rates would satisfy

FAR′(T₀)∈I_{FAR}=[FAR(5.941)−ϵ̅,FAR(5.941)+ϵ̅]=[0.02365,0.04365]

and

FRR′(T₀)∈I_{FRR}=[FRR(5.941)−ϵ̅,FRR(5.941)+ϵ̅]=[0.02358,0.04358].

Following the next step in Algorithm 1, the error rates obtained from the evaluation of the dataset are analyzed. It was found that the smallest ϵ with such that

[FAR(5.941−ϵ),FAR(5.041+ϵ)]⊆I_{FAR} and [FRR(5.941+ϵ),FRR(5.941−ϵ)]⊆I_{FRR}

is ϵ=0.093. This initializes

s₀=└n^{1/p}/ϵ┘=└128/0.093┘=1376

in Algorithm 1 (note that p=1 in the Manhattan distance function).

Next, a suitable value for MinScalar is selected. For this, the average feature vector a=[a₁, . . . , a₁₂₈] over all 13,233 feature vectors in the LFW dataset, where aᵢ is the average of the absolute values of the i′th components of the feature vectors. It was found that

min(a)=min({aᵢ})=0.035,max(a)=max({aᵢ})=0.37

with an average of

Mean(a)=Σaᵢ/128=0.098.

Therefore, s=MinScalar=100 was chosen. The following was obtained

min(StRₛ(a))=4,max(StRₛ(a))=37

with an average of

Mean(StRₛ(a))=10.

This ensures that creating a dictionary for the set of transformed feature vectors is an infeasible task for an attacker because 10¹²⁸ feature vectors are expected on average.

Finally, after the while loop in Algorithm 1, the following is obtained

s₀=100 and T₀=└s₀t₀┘=594,

and the new system's rates as

FAR′(594)=0.03428 and FRR′(594)=0.033617,

which are extremely close to the original system's rates. Please see TABLE 2 for a complete list of parameters for the new system derived from the original system with the threshold values of t₀=4.846, t₀=5.393 and t₀=5.941.

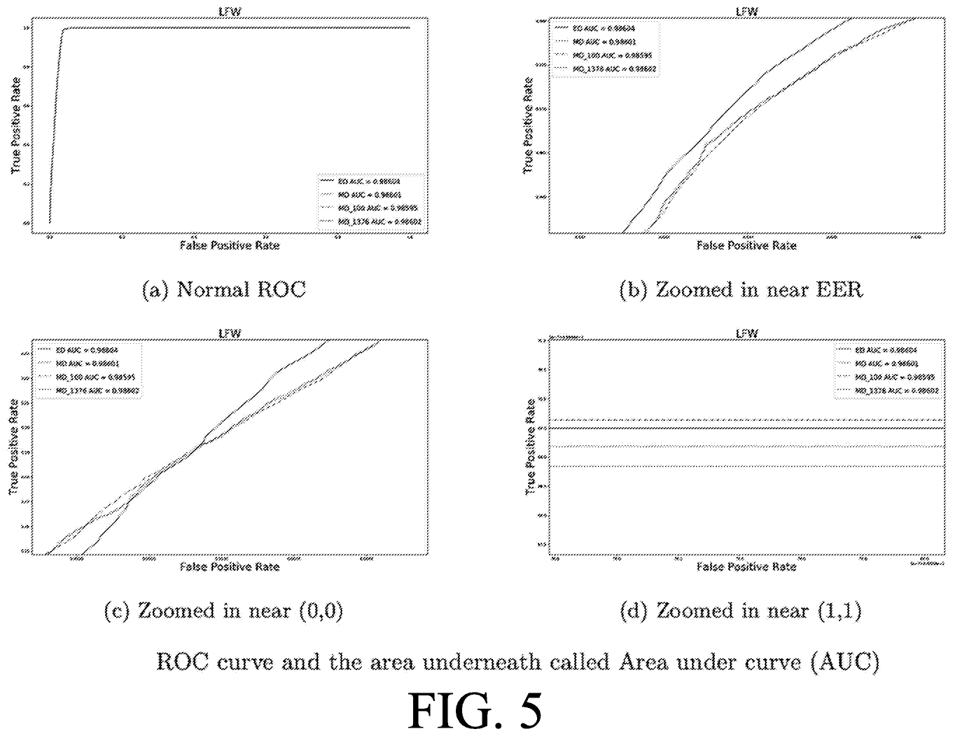

In FIG. 5, the ROC curve and the AUC are shown for an ED algorithm, an MD algorithm, an MD₁₀₀ algorithm, and an MD₁₃₇₆ algorithm. The curves in FIG. 5a depict that the differences among the used techniques are very small which is further supported by AUC. It shows that the AUC of ED and MD are 0.98604 and 0.98601, respectively. In other words, the area differ by 0.00003 only. Furthermore, it was found that the AUC of MD₁₀₀ and MD₁₃₇₆ as 0.98595 and 0.98602, respectively. Clearly, MD₁₃₇₆ is a better choice than MD₁₀₀ in terms of accuracy. But we find that the loss of 0.00006 in accuracy, if we use MD₁₀₀. is very very small w.r.t. the loss computational efficiency if MD₁₃₇₆ is deployed. The ROC curves differences among our used techniques near the EER neighborhood is shown in FIG. 5b. The curves of ED, MD, MD₁₀₀ and MD₁₃₇₆ may cross each other as is shown in FIG. 1c which is close to the coordinates (0, 0). FIG. 1d shows that as the curves get close to the coordinates (1, 1), a fixed pattern is produced.

Keystroke-dynamics. The keystroke-dynamics dataset of Killourhy and Maxion is publicly available. The dataset contains the keystroke-timing of 51 subjects typing the same password in 8 different sessions where each session consists of 50-repetition and only one session per day was performed. From each (password) typing event, 31 timing features were extracted. 14 anomaly-detection algorithms were implemented using the R statistical programming language. The performance of each detector was measured by generating an ROC curve using the anomaly scores. The authors have reported 0.153 as the average EER using MD function. Note that the subject identifiers are not in the range of s001 to s051.

Using the MD, the error rates were computed. Also, two subjects were selected that show minimum and maximum EER. Actually, these two subjects are tantamount to the best- and worst-case which are believe to be the best candidates to show the impact of the present transformation. If the two extreme error rates satisfy the conditions, then do all the other values because they lie in the range of the two extremes. Using the Python programming language, it was found that the average EER to be 0.153 which same as that previously reported.

Transforming Keystroke Feature Vectors. After computing the error rates for each of the 51-subjects, the implementation results show that subjects s055 and s049 have minimum and maximum EER, respectively. In TABLE 3, the error rates of both s055 and s049 are provided at EER threshold points. In this context the length of the feature vector is 31. It was found that t₀=1.510 and t₀=6.719 as the EER threshold for s055 and s049, respectively. Using the FRR and FAR values at EER threshold, for s055, ϵ̅=0.005 was chosen such that

FAR′(T₀)∈I_{FAR}=[FAR(1.510)−ϵ̅,FAR(1.510)+ϵ̅]=[0.007,0.017],

and

FRR′(T₀)∈I_{FRR}=[FRR(1.510)−ϵ̅,FRR(1.510)+ϵ̅]=[0.005,0.015].

Similarly, for s049, ϵ̅=0.001 was chosen such that

FAR′(T₀)∈I_{FAR}=[FAR(6.719)−ϵ̅,FAR(6.719)+ϵ̅]=[0.47,0.49],

And

FRR′(T₀)∈I_{FRR}=[FRR(6.719)−ϵ̅,FRR(6.719)+ϵ̅]=[0.47,0.49].

Following the next step in the Algorithm 1, the error rates of s055 and s049 computed for the dataset are analyzed. The smallest c=0.062 and c=0.019 for s055 and s049, respectively, such that FAR′ and FRR′ lie in the range of the error rates of the corresponding subject. In other words, the starting value are

sₛ₀₅₅=└31/0.062┘=500,

and

sₛ₀₄₉=└31/0.019┘=1632.

Next, a suitable value for MinScalar is selected. For this, the average feature vector a=[a₁, . . . , a₃₁] is computed over all 400 feature vectors of each subject, where aᵢ is the average of the absolute values of the i′th component of the feature vectors. For s055, it is found that min(a)=0.0184, max(a)=0.2344 and Mean(a)=Σaᵢ/31=0.0964. Therefore, the value of MinScalar is selected to be 100, and obtain min(StRₛ(a))=2, max(StRₛ(a))=23 and Mean(StRₛ(a))=10. This ensures that creating a dictionary for the set of transformed feature vectors is an in-feasible task for an attacker because 10³¹≈2⁹³ feature vectors are expected on average. Finally, after the while loop in Algorithm 1, the following is obtained

s₀=100 and T₀=└s₀t₀┘=151,

and tne new system's rate as

FAR′(151)=0.012 and FRR′(151)=0.010,

which are extremely close to the original system's rates. TABLE 3 includes a complete list of parameters for the new system derived from the original system. As expected, the new system's rates are close to the original system's rates. Similarly, the same operations for s049 were performed, and the results are provided in TABLE 3.

TABLE 3

EER

| Method | s055 | s049 |
|---|---|---|
| MD | t = 1.510 | t = 0.719 |
| | FRR = 0.010 | FRR = 0.480 |
| | FAR = 0.012 | FAR = 0.480 |
| MDₛ | s = 100 | s = 274 |
| | t = 151 | t = 1841 |
| | FRR′ = 0.010 | FRR′ = 0.475 |
| | FAR′ = 0.012 | FAR′ = 0.480 |
| | s = 500 | s = 1632 |
| | t = 755 | t = 10058 |
| | FRR′ = 0.010 | FRR′ = 0.48 |
| | FAR′ = 0.012 | FAR′ = 0.48 |

In TABLE 3, the FRR and FAR values for the subjects s055 and s049 at EER threshold points are determined by computing the MD using both real- and integer-valued feature vectors. For integer-valued, the feature vectors are scaled-then-rounded using the different values of the (selected) scalars s to find the minimum one.

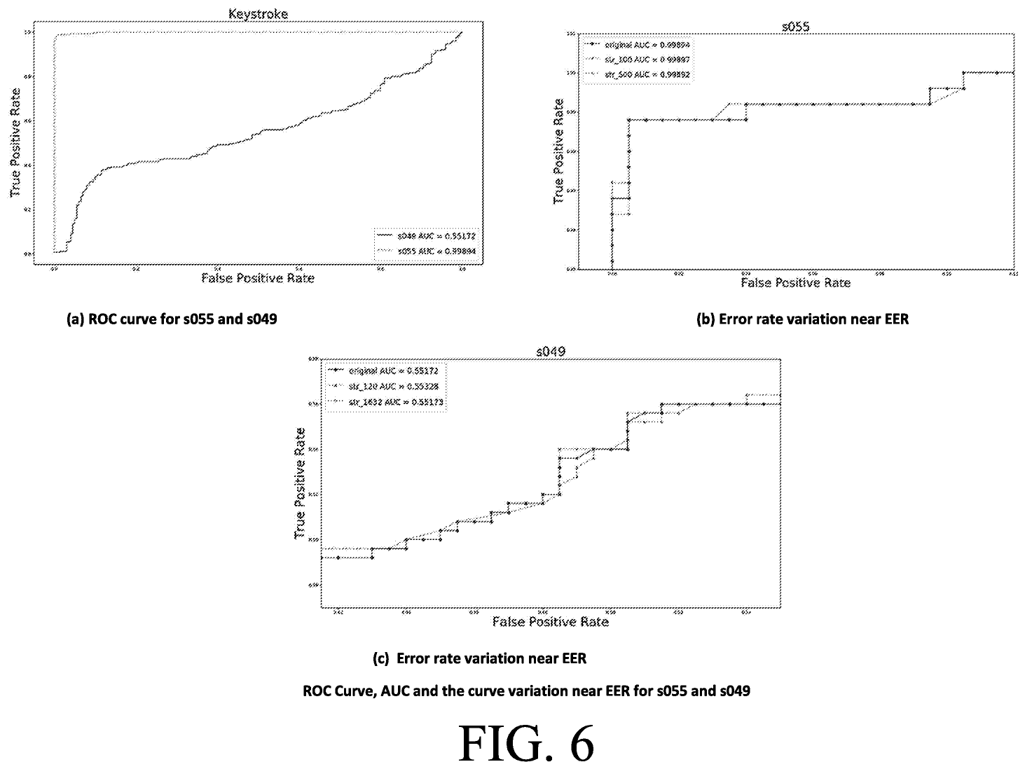

Like the face biometric, the ROC curve and AUC are provided in FIG. 6. The larger the AUC, the better the ROC curve. Therefore, the ROC curve and AUC of s055 is much better than s049 as shown in FIG. 6a. The AUC of s055 and s049 are 0.99894 and 0.55172, respectively. It is evident that all the other subjects' curves and AUCs lie between the two curves in FIG. 6a. To show the effects of the choice of scalars, the ROC curves is provided near the EER of s055 and s049 in FIG. 6b and FIG. 6c, respectively. From both figures, clearly, the winner is larger scalars. In the case of s055, the AUC value is 0.99897 and 0.99892 by using s=100 and s=500, respectively. Similarly, the AUC value is 0.55328 and 0.55173 by using s=120 and s=1632, respectively. Hence, the larger scalar has a better accuracy than that of the original system as shown in FIG. 6b and FIG. 6c.

Case Analysis: Secure Templates from Real-Valued Feature Vectors

Thus far, a method for transforming biometric authentication systems based on real-valued feature vectors into biometric authentication systems based on integer-valued feature vectors has been proposed and analyzed. This allows real-valued feature vectors to be used as inputs to some cryptographic algorithms, whereby the security of the matching algorithms is enhanced and the accuracy rates of the original (non-cryptographic) systems are preserved.

In the following sections, the present solution is more concretely described by implementing an algorithm NTT-Sec over the biometric dataset. NTT-Sec works with binary feature vectors by design. On the other hand, the biometric dataset, after applying our accuracy-preserving transformation, consists of integer-valued feature vectors. Therefore, NTT-Sec is first modified to NTT-Sec-R.

The original NTT-Sec is based on two algorithms called Proj (project) and Decomp (decompose). The Proj algorithm maps (projects) a fixed-length binary vector (considered as the feature vector) to a finite field element (considered as its secure template) using a priori-fixed set of public parameters and a factor basis. Given a pair of secure templates, the Decomp algorithm can detect whether the templates originate from a pair of binary feature vectors that differ in at most t indices for some priori-fixed error threshold value t. In Decomp, the detection is achieved by checking whether a particular finite field element can be written (decomposed) as a product of the factor basis elements in a certain form.

A New Construction: NTT-Sec-R

Assume that n and t are some fixed values that represent the length of feature vectors and the system threshold value, respectively. Choose a scaling factor s (to be used in StRₛ transformation), a prime number p such that p>2n, an integer m such that m≥└st┘, a set B={g₁, g₂, . . . , gₙ} such that 1<gᵢ<(p−1)/2 for each i. Using these, NTT-Hash-R and NTT-Match-R are defined where their descriptions follow the original NTT-Sec, while a new transformation is introduced using the scaling factor s which helps to transform the real-valued feature vectors to integer-valued vectors.

Construction of G.

Let F_{q} be a finite field with q elements where q=p^{m}. Let cϵF_{q} be a non-quadratic residue with minimal polynomial of degree m over Fₚ. Let F_{q}2=F_{q}(σ) be a degree two extension of F_{q} where σ is a root of x²−c. F_{q}2 has a cyclotomic subgroup G of order q and every non-identity element in G can be represented as

$$\frac{a + σ}{a - σ}$$

for some aϵF_{q}. Moreover, an element aϵG is k-decomposable over Fₚ, if it can be written as a product

$$a = {\prod }_{i = 1}^{k} ( \frac{{a}_{i} + σ}{{a}_{i} - σ} )$$

for some Fₚ-elements a₁, a₂, . . . , aₖ.

NTT-Hash-R Algorithm. This algorithm maps a given real-valued feature vector x=(x₁, x₂, . . . , xₙ) to a G-element called hash as follows: It first computes X=(X₁, . . . , Xₙ)=StRₛ(x) using the StRₛ transformation. Then using the basis B={g1, g2, . . . . , gₙ}, it computes the hash value

$$NTT \text{-} Hash - ℝ ( x ) = {\prod }_{i = 1}^{n} {( \frac{{g}_{i} + σ}{{g}_{i} - σ} )}^{{X}_{i}} .$$

NTT-Match-R Algorithm. Assume a hash value hₓ=NTT-Hash-R(x) for some x=(x₁, . . . , xₙ), a real-valued vector y=(y₁, . . . . , yₙ) and a positive real number t are given. The goal of NTT-Match-R is to decide whether Σᵢ₌₁|xᵢ−yᵢ|≤t or not. To achieve this goal, the following process is performed. h_{y}=NTT-Hash-R(y) is computed using NTT-Hash-R. Then, a decision is made whether the G-element h/h_{y} is └st┘-decomposable. Furthermore, if the retrieved Fₚ-elements belong to the basis B, NTT-Match-R returns Match, otherwise No—Match. All of the above described parameters are packed under a set SP={n, t, s, p, m, B}, which is referred to herein as a system parameter set.

Implementation Results

In this section, the implementation details of the NTT-Sec-R algorithm is discussed using a public dataset. Moreover, the error rates and timing results are provided. Confirmation is made that NTI-Sec-R does not alter the accuracy-preserving properties of the present solution's construction, as expected. The results also show that parameters in the present solution's transformation can be chosen to balance computational efficiency and system accuracy. All the codes are written in C programming language and the results are obtained on the same machine. The machine is an Intel Core i7-7700 CPU @ 3.60 GHz desktop computer and running Ubuntu 16.04 LTS.

It is expected that the FRR and FAR values of the NTT-Sec-R algorithm will be close to that of the MD where the rounded scaled-values of the dataset are used. Following the same convention of minimum and maximum EER, the FRR and FAR results are presented for subject s055 and s049 at the three pivotal-threshold points. The error rates results using the scalar 93 are presented in below TABLE 4. For s055, by comparing the results in Table 4 and below Table 5, it is found that the FAR/FRR values match perfectly. Similarly, for s049, the comparison of Table 4 and Table 5 shows that FAR/FRR values match perfectly. Therefore, the NTI-Sec-R algorithm preserves the accuracy of the (non-cryptographic) MD while enhancing the security and privacy aspects.

TABLE 4
Scalar = 93

| s055 | | | s049 | | |
|---|---|---|---|---|---|
| Threshold | FRR | FAR | Threshold | FRR | FAR |
| 107 | 0.100 | 0.0 | 267 | 1.0 | 0.004 |
| 140 | 0.010 | 0.012 | 625 | 0.485 | 0.484 |
| 182 | 0.0 | 0.028 | 1406 | 0.0 | 0.992 |

In TABLE 4, the FRR and FAR values are provided for the subject s055 and s049 using the scalar 93 in the implementation of the NTT-Sec-R algorithm. The threshold values correspond to the three pivotal-threshold points.

TABLE 5

| | | | | | | | | | Timings | | |
|---|---|---|---|---|---|---|---|---|---|---|---|
| | | | | | | Crypto | | | Tem- | | |
| | | GARUOFAR | | EER | | User | No | | plate | | Secu- |
| | Dataset | Before* | After* | Before* | After* | Secret | Secret | Accuracy | gen. | Matching | rity |
| Feng | FERET | N/A | N/A | 21.66% | 3.62% | DP | | N/A | | 1.67 × 10⁻⁴ sec | |
| et. al. | CMU-PIE | | | 18.18% | 8.26% | trans- | | | | 1.41 × 10⁻⁴ sec | |
| [14] | FRGC | | | 31.75% | 9.13% | form | | | | 3.01 × 10⁻⁴ sec | |
| Chen | IJB-A | 0.838 ± 0.042 | N/A | N/A | N/A | N/A | N/A | N/A | N/A | N/A | N/A |
| et. al. | LFW | (FAR = 0.01) | | | | | | 97.45% ± 0.7% | | | |
| [11] | | | | | | | | | | | |
| Pandey | Extended | N/A | 96.49 ± 2.30% | N/A | 0.71 ± 0.17% | Binary | | N/A | | | |
| et. al. | Yale B | | | | | code | | | | | |
| [32j | CMU-PIE | | 00.13 ± 4.30% | | 1.14 ± 0.14% | | | | | | |
| | Multi-PIE | | 07.12 ± 0.45% | | 0.00 ± 0.13% | | | | | | |
| Our | LFW | 89.99% | 00.09% | 3.36% | 3.39% | N/A | | | 68.17 | 300.07 ms | |
| | Keystroke | | | | | | | | ms | | |

The results in Table 4 and Table 5 show that larger choices of scalars yield a system whose accuracy better approximates the accuracy of the original system. However, large scalars degrade the computational efficiency of the NTT-Sec-R algorithm because computations are performed in larger algebraic structures with larger threshold values. For simplicity, the error rates for the scalar value of s=93 are reported. Out of the three pivotal-threshold points, the one for EER is selected because of its common use in literature. For s055, the timing tests show the average CPU time of 14.253 milliseconds using the threshold value of 140. On the other hand, the average CPU time of 447.596 milliseconds is found using the threshold 625 for s049. Note that, even though the choice of s=93 provides a practical run time in practice, there is still big room for speedups because the timings are based on a high level implementation of the algorithms and only the GCC compiler is utilized for optimization. It has been verified in experiments that larger choices of scalars degrade the computational efficiency of NTT-Sec-R algorithm. For example, by using the scalar 3100, the average CPU time of 71029.583 milliseconds occurs at the threshold 4681 for the subject s055.

Security Discussion

The security of NTT-Sec-R should be discussed with respect to the irreversibility and indistinguishability notions. These notions are formally modelled between a challenger and a computationally bounded adversary. For irreversibility, several attacks have been considered in prior art systems, including guessing attack, brute force attack, and discrete logarithm attack. In these systems, reversing the templates is the best strategy for an adversary. The best strategy for an adversary to attack our modified NTT-Sec-R (with respect to both irreversibility and indistinguishability notions) is to solve the discrete logarithm problem in the underlying cyclotomic group.

Assuming g is a generator of G, the adversary solves e:=log_{g} h and eᵢ:=log_{g} g for each i=1, . . . , n using a discrete-logarithm solver. Then she gets an equation

$$e = {\sum }_{i = 1}^{n} {e}_{i} {X}_{i} mod {p}^{m}$$

since |G|=p^{m}. Using a Knapsack-solver, a solution X₁, . . . , Xₙ is found, and thus X is recovered. Assuming the cost of computing the discrete logarithm of an element in G is C_{DLP} and the cost of solving the above modular Knapsack problem is C_{Knapsack}, then the total cost is

(n+1)C_{DLP}+C_{Knapsack}

The best known algorithm to solve the discrete logarithm problem in F_{q2}, where q=p^{m} with typically small characteristic (i.e., p=ln p^{2m}^{^{O(1)}}), runs in quasi-polynomial time 2O^{(ln ln p}^{^{2m}}⁾^{²}. Ignoring the cost C_{Knapsack} of the underlying Knapsack problem, the cost of this discrete logarithm attack is estimated to be (n+1)2^{(ln ln p}^{^{2m}}⁾^{²}. For example, given the parameters for the Subject s055 and Subject s049 in the implementation (n=31, p=127, m=140, m=625), the cost of this attack is estimated to be 2⁵⁷ and 2⁸¹, respectively.

Above, a generic method to extend the domain of biometric template protection algorithms from integer-valued feature vectors to real-valued feature vectors was described. This generic method was shown as being accuracy-preserving in the sense that the accuracy of the new system can be made arbitrarily close to the accuracy of the original system. This allows real-valued feature vectors to be used as inputs to some cryptographic algorithms, whereby the security of the matching algorithms is enhanced while the accuracy rates of the original (non-cryptographic) systems is preserved. The theoretical findings were verified by implementing a recent secure biometric template generation algorithm over a public keystroke dynamics dataset.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

What is claimed is:

1. A method for generating a secure biometric template, comprising:
obtaining, by a computing device, biometric data from an individual, the biometric data represented as a real-valued feature vector x;
mapping, by the computing device, the real-valued feature vector x to an integer-valued feature vector X by multiplying each component of the real-valued feature vector x by a value s and performing a nearest integer function using results of the multiplying, where s is a function of n, p and ϵ̅, n is the length of the real-valued feature vector x, p is a known parameter of a distance function used to determine a distance between two biometric templates, and ϵ̅ is a parameter ensuring retention of biometric data accuracy while the biometric template is being generated;
generating, by the computing device, the secure biometric template by a cryptographic algorithm using the integer-valued feature vector X as an input; and
using the secure biometric template data for computer security purposes.

2. The method according to claim 1, wherein the cryptographic algorithm comprises an NTT-Sec-R algorithm.

3. The method according to claim 1, further comprising storing the secure biometric template in a data store.

4. The method according to claim 1, further comprising using the stored secure biometric template as a reference biometric template in a user authentication process.

5. The method according to claim 4, wherein the user authentication process comprises:
obtaining biometric data from the individual or another individual, the biometric data represented as a real-valued feature vector y;
mapping the real-valued feature vector y to an integer-valued feature vector Y by multiplying each real number of the real-valued feature vector y by the value s and performing a nearest integer function using results of the multiplying; and
generating a new secure biometric template by a cryptographic algorithm using the integer-valued feature vector Y.

6. The method according to claim 5, further comprising performing an algorithm to determine a distance between the new biometric template and the reference biometric template.

7. The method according to claim 6, further comprising comparing the distance d to a threshold value T that is a function of s.

8. The method according to claim 7, further comprising authenticating the individual or the another individual when the distance d is equal to or less than the threshold value T.

9. The method according to claim 8, further comprising setting the threshold value T equal to the nearest integer of the product of s and t.

10. The method according to claim 1, wherein s is greater than or equal to n^{1/p}/ϵ.

11. The method according to claim 1, further comprising selecting the value s by obtaining inputs:
a biometric dataset DS;
a threshold value t with reference to a desired false accept rate and a desired false reject rate simulated over DS;
I_{FAR} which is defined by Equation I_{FAR}=[FAR1, FAR2]=[FAR(t)−ϵ̅, FAR(t)+ϵ̅], where FAR(t) comprises a value that represents a measure of the likelihood that a biometric security system will incorrectly accept an access attempt by an unauthorized user;
I_{FRR} which is defined by Equation I_{FRR}=[FRR1, FRR2]=[FRR(t)−ϵ̅, FRR(t)+ϵ̅], where FRR(t) comprise a value that represents a measure of the likelihood that the biometric security system will incorrectly reject an access attempt by an authorized user;
ϵ̅ which represents a value that is selected so that FAR′(T) lies in [FAR1, FAR2] of I_{FAR}, and FRR′(T) lies in [FRR1, FRR2] of I_{FRR}; and
MinScalar is defined by following procedure: 1) compute the average of feature vector over all feature vectors in the dataset, depending on the (user-based or system-based) model, such that each component of the vector is the average of the absolute values of that component; 2) determine whether
FAR′((s−1)·t)∈I_{FAR} and FRR′((s−1)·t)∈I_{FRR}
over the biometric dataset DS. [symbol] is selected as s when a determination is made that
FAR′((s−1)·t)∈I_{FAR} and FRR′((s−1)·t)∈I_{FRR}
are not met.

12. The method according to claim 11, further comprising determining a smallest ϵ such that [FAR(t−ϵ), FAR(t+ϵ)]⊆I_{FAR} and [FRR(t+ϵ), FRR(t−ϵ)]⊆I_{FAR}.

13. The method according to claim 12, further comprising:
setting s set equal to [symbol] ;
continuously subtracting 1 from s as long as the following three conditions are met: s>MinScalar, FAR′((s−1)·t)∈I_{FAR} and FRR′((s−1)·t)∈I_{FRR} over the biometric dataset DS.

14. A system, comprising:
a processor;
a non-transitory computer-readable storage medium comprising programming instructions that are configured to cause the processor to implement a method for generating a secure biometric template, wherein the programming instructions comprise instructions to:
obtain biometric data from an individual, the biometric data represented as a real-valued feature vector x;
map the real-valued feature vector x to an integer-valued feature vector X by multiplying each component of the real-valued feature vector x by a value s and performing a nearest integer function using results of the multiplying, where s is a function of n, p and ϵ̅, n is a length of the real-valued feature vector x, p is a known parameter of a distance function used to determine a distance between two biometric templates, and ϵ̅ is a parameter ensuring retention of biometric data accuracy while the biometric template is being generated;
generate the secure biometric template by a cryptographic algorithm using the integer-valued feature vector X as an input; and
use the secure biometric template for computer security purposes.

15. The system according to claim 14, wherein the cryptographic algorithm comprises an NTT-SEC-R algorithm.

16. The system according to claim 14, wherein the programming instructions comprise instructions to store the secure biometric template in a data store.

17. The system according to claim 14, wherein the programming instructions comprise instructions to use the stored secure biometric template as a reference biometric template in a user authentication process.

18. The system according to claim 17, wherein the user authentication process comprises:
obtaining biometric data from the individual or another individual, the biometric data represented as a real-valued feature vector y;
mapping the real-valued feature vector y to an integer-valued feature vector Y by multiplying each real number of the real-valued feature vector y by the value s and performing a nearest integer function using results of the multiplying; and
generating a new secure biometric template by a cryptographic algorithm using the integer-valued feature vector Y.

19. The system according to claim 18, wherein the user authentication process further comprises performing an algorithm to determine a distance between the new biometric template and the reference biometric template.

20. The system according to claim 19, wherein the user authentication process further comprises comparing the distance d to a threshold value T that is a function of s.

21. The system according to claim 14, wherein the user authentication process further comprises authenticating the individual or another individual when the distance d is equal to or less than the threshold value T.

22. The system according to claim 14, wherein s is greater than or equal to n^{1/p}/ϵ.

23. The system according to claim 14, wherein the programming instructions comprise instructions to select the value s by obtaining inputs:
a biometric dataset DS;
a threshold value t with reference to a desired false accept rate and a desired false reject rate simulated over DS;
I_{FAR} which is defined by Equation I_{FAR}=[FAR1, FAR2]=[FAR(t)−ϵ̅, FAR(t)+ϵ̅], where FAR(t) comprises a value that represents a measure of the likelihood that a biometric security system will incorrectly accept an access attempt by an unauthorized user;
I_{FRR} which is defined by Equation I_{FRR}=[FRR1, FRR2]=[FRR(t)−ϵ̅, FRR(t)+ϵ̅], where FRR(t) comprise a value that represents a measure of the likelihood that the biometric security system will incorrectly reject an access attempt by an unauthorized user; and
ϵ̅ which represents a value that is selected so that FAR′(T) lies in the range of FAR1 and FAR2 of I_{FAR}, and FRR′(T) lies in the range of FRR1 and FRR2 of I_{FRR}; and
MinScalar is defined by following procedure: 1) compute the average of feature vector over all feature vectors in the dataset, depending on the (user-based or system-based) model, such that each component of the vector is the average of the absolute values of that component; 2) determine whether
FAR′((s−1)·t)∈I_{FAR} and FRR′((s−1)·t)∈I_{FRR}
over the biometric dataset DS. [symbol] is selected as s when a determination is made that
FAR′((s−1)·t)∈I_{FAR} and FRR′((s−1)·t)∈I_{FRR}
are not met.

24. The system according to claim 23, wherein the programming instructions comprise instructions to determine a smallest ϵ such that
[FAR(t−ϵ),FAR(t+ϵ)]⊆I_{FAR} and [FRR(t+ϵ),FRR(t−ϵ)]⊆I_{FAR}.

25. The system according to claim 24, wherein the programming instructions comprise instructions to set s set equal to [symbol] .

26. The system according to claim 25, wherein the programming instructions comprise instructions to determine whether FAR′((s−1)·t)∈I_{FAR} and FRR′((s−1)·t)∈I_{FRR} over the biometric dataset DS.

27. The system according to claim 26, wherein the programming instructions comprise instructions to select [symbol] as s when a determination is made that FAR′((s−1)·t)∈I_{FAR} and FRR′((s−1)·t)∈I_{FRR} are not met.

28. The system according to claim 27, wherein the programming instructions comprise instructions to subtract 1 from s when a determination is made that FAR′((s−1)·t)∈I_{FAR} and FRR′((s−1)·t)∈I_{FRR} are met, and comparing the result of the subtracting to MinScalar.

29. The system according to claim 28, wherein the programming instructions comprise instructions to set s equal to [symbol] when the result of the subtracting is greater than MinScalar.
